(19) United States
(12) Patent Application Publication
(10) Pub. No.: US 2016/0078205 A1
(43) Pub. Date: Mar. 17, 2016

(54) DISPLACEMENT SIGNATURES

(71) Applicant: HEWLETT-PACKARD DEVELOPMENT COMPANY, L.P., Houston, TX (US)

(72) Inventors: Alistair Coles, Bristol (GB); Aled Edwards, Bristol (GB); Christopher Newton, Bristol (GB)

(21) Appl. No.: 14/784,667

(22) PCT Filed: Apr. 24, 2013
(86) PCT No.: PCT/US13/38023

§ 371 Date: Oct. 15, 2015

(51) Int. Cl. G06F 21/31

(52) U.S. Cl. CPC G06F 21/31

(57) ABSTRACT

In one implementation, a security management system accesses a displacement signature defined in relation to physical contact with a surface and determines that the displacement signature is correlated with a known displacement signature. The security management system then performs an operation in response to determining that the displacement signature is correlated with the known displacement signature.

### BACKGROUND

In many systems, establishment of a trusted state of an entity depends on a credential or secret held by that entity. For example, an entity can log into a network-based service or resource by providing a credential such as a password to that service to establish a trusted state of that entity within that service. The entity can typically perform privileged operations after logging into that service until the trusted state is revoked. The trusted state can be revoked when the entity is logged out of the service at its request or in response to some condition such as a forbidden or invalid operation (or request for an operation).

Similarly, in some systems, the trusted state of an entity depends on a credential demonstrated by a relationship of that entity with another system. For example, a trusted state of an entity can be established within a network-based service or resource so long as the entity communicates with that service via a communications link established between that service and another system (e.g., an enterprise intra-network). As another example, a trusted state of an entity can be established within a network-based service or resource so long as another system verifies to that service that the entity has a trusted state within the other system.

### BRIEF DESCRIPTION OF THE DRAWINGS

FIG. 1 is a flowchart of a security management process, according to an implementation.

FIG. 2 illustrates definition of a displacement signature of a tactile tag, according to an implementation.

FIG. 3 illustrates a tactile tag, according to another implementation.

FIG. 4 is a schematic block diagram of an environment including a security management system, according to an implementation.

FIG. 5 is a flowchart of a security management process, according to another implementation.

FIG. 6 is a schematic block diagram of a computing system hosting a security management system, according to an implementation.

### DETAILED DESCRIPTION

A trusted state of an entity is typically established for or within a service (or resource) after the entity demonstrates that it has access to some credential or group of credentials. As discussed above, such a credential can be a secret such as a password, a token, or a relationship (e.g., a trusted or secure communications session) with another system. As another example, the entity can provide a signed statement (e.g., data set) about its identity that can be verified to be from or of a party that is trusted to make such statements, where a credential is used to verify the statement is from that party. Credentials such as a private key or a public/private encryption key pair, a symmetric encryption key, or some other secret or private data can be used for such verification.

Alternatively, a trusted state of an entity can be established for a service if the entity or some device associated with the entity is located in a particular geographic location. For example, using a positioning system such as the Global Positioning System (GPS) a device can determine its location, and provide that location to the service. If the location is within a region approved or authorized by the service, a trusted state of the entity for the service can be established. In some implementations, such a GPS locator (or receiver) can be a trusted GPS locator that includes one or more security modules that can be used to validate or verify that data output from the trusted GPS locator are authentic (e.g., have not been tampered with).

In some applications, a trusted state of an entity is established and maintained (e.g., not revoked) while a device associated with that entity is at or near a particular location. Some such applications required that a trusted state of an entity should only be established and maintained while a device associated with that entity is at or near a particular location where traditional positioning systems are not available (e.g., where GPS satellites or other beacons cannot be received or sensed).

Implementations discussed herein determine whether a device associated with an entity is at or near a particular location based on physical contact of the device with a surface. As an example, implementations discussed herein define a displacement signature in relation to physical contact with a surface and perform operations after determining that the displacement signature is correlated with a known displacement signature. As a specific example, a displacement module can define a displacement signature for a tactile tag (or surface of a tactile tag) with a known (e.g., previously determined or defined) displacement signature. If the displacement signature defined by the displacement module is correlated with (e.g., matches or substantially matches) the known displacement signature of the tactile tag, a trusted state of an entity is established.

Moreover, in some implementations discussed herein, after defining the displacement signature the displacement module monitors movement of the displacement module (or a device including the displacement module). If the displacement module determines that the displacement module has moved more than a threshold distance, a trust state of the entity can be revoked. Thus, a trust state of an entity can be established through physical contact with a surface, and revoked after a displacement module moves (or is moved) more than a threshold distance from the surface.

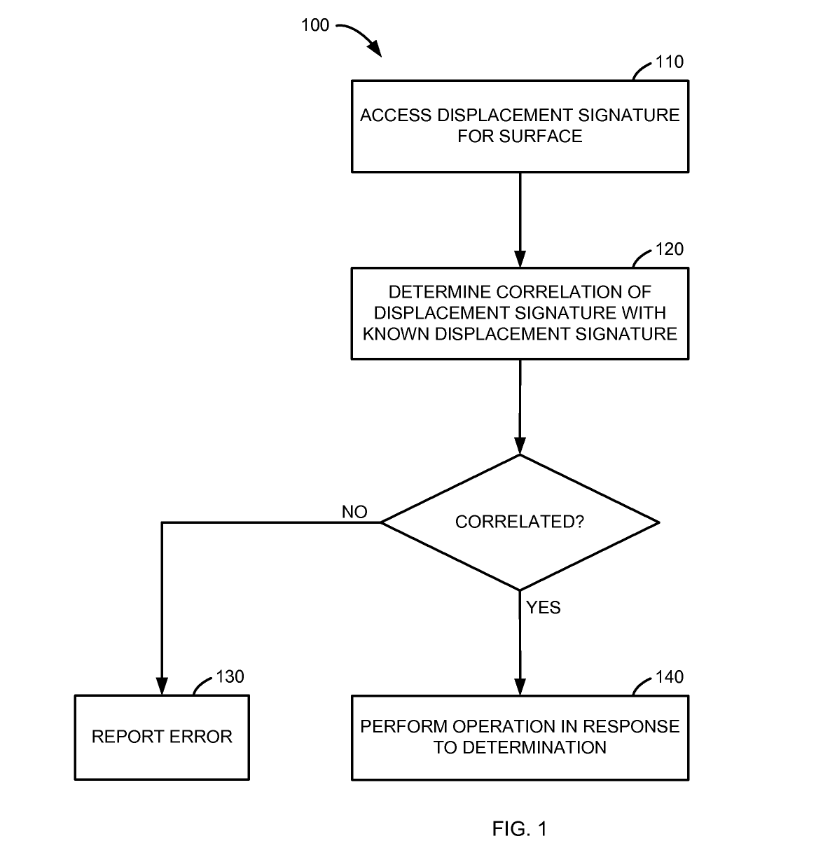

FIG. 1 is a flowchart of a security management process, according to an implementation. Process 100 can be implemented, for example, at a security management system hosted at a computing system. At block 110, a displacement signature for a surface is accessed. For example, the displacement signature can be accessed at a memory of a security management system. In some implementations the displacement signature can be accessed at a memory of a security management system after being generated at a displacement module, retrieved from a data store such as a database, or received from a device.

A displacement signature is a representation of displacement at or along a surface, and can be in any of a variety of representations. In other words, a displacement signature is defined in relation to physical contact with a surface. Said differently, a displacement signature represents the displacement of an object during physical contact with the surface. For example, a displacement signature can represent displacement of an object in one or more directions that are perpendicular to a direction of movement of the object along the surface.

Physical contact with a surface (or tactile tag) can be direct or indirect. Direct physical contact means that a device touches the surface. For example, a smartphone is in direct physical contact with a tactile tag if a portion of the smartphone touches or comes into contact with the tactile tag. Indirect physical contact means that a device does not touch the surface, but touches some other object that—directly or indirectly—touches the surface. For example, a displacement module can be embedded within a ring and in communication with other components of a security management system. Rather than move the ring along the surface of a tactile tag, the hand of a person on which the ring is worn can be moved along the surface of the tactile tag. Accordingly, a displacement signature can be defined by indirect physical contact of the ring (through the hand) with the surface. As another example, rather than touch a smartphone to a tactile tag, a person can hold a smartphone in her hand, and bring her hand into contact with the tactile tag.

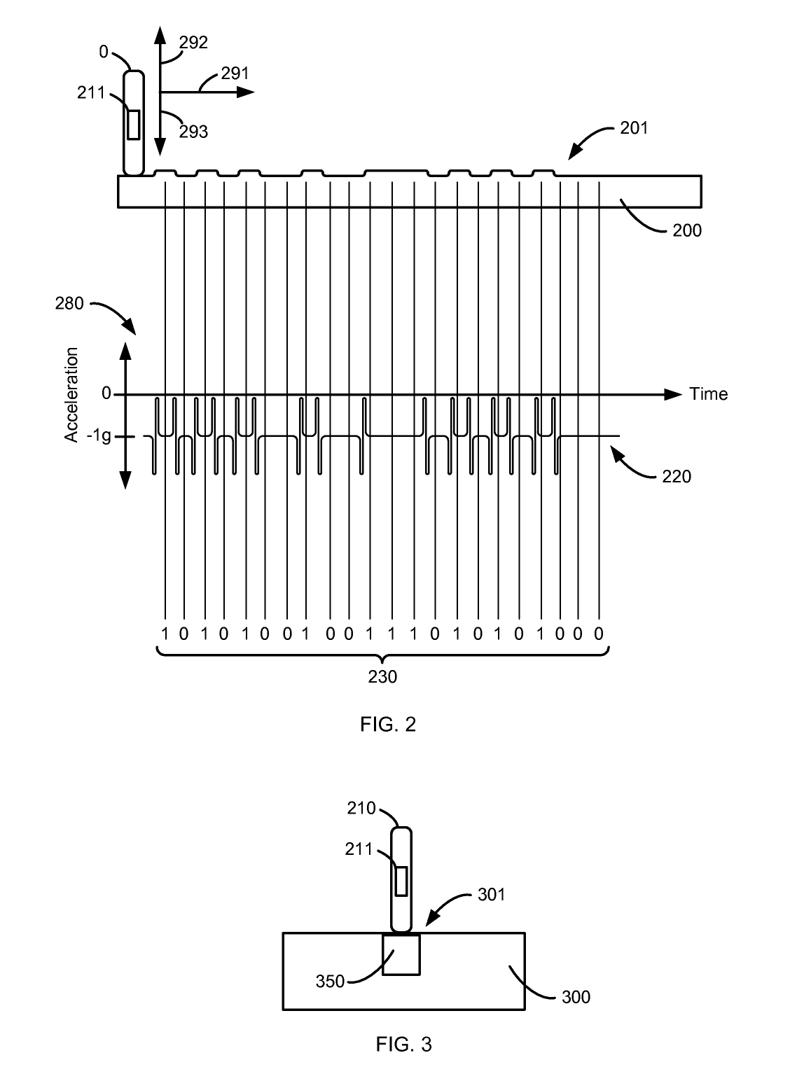

As a specific example, FIG. 2 illustrates definition of a displacement signature of a tactile tag, according to an implementation. A tactile tag is an apparatus that displaces objects on its surface. For example, tactile tag 200 is an apparatus that includes a series of protrusions and depressions. Protrusions are portions of a tactile tag that are raised with respect to depressions. Depressions are portions of a tactile tag that are depressed with respect to protrusions. Typically, the series of protrusions and depressions of a tactile tag define a pattern that is sufficiently unique to uniquely identify the tactile tag from other tactile tags in a group of tactile tags.

In some implementations, a tactile tag is difficult to copy or reproduce. For example, physical barriers or security can be placed around a tactile tag to limit access and/or windows can be excluded from a room including a tactile tag. In other implementations, a tactile tag can be made from a material of a single color or be transparent and illuminated by substantially uniform light to prevent photographic capture of the feature of the tactile tag. In some implementations, a tactile tag can be made from a material that is substantially non-reflective or that is low-reflective to prevent optical or laser scanning of the tactile tag. In other implementations, other measures can be taken to complicate copy or reproduction of tactile tags.

As noted above, a displacement signature is a representation of displacement at or along a surface, and can be in any of a variety of representations. For example, a displacement signature can be a waveform such as waveform 220. As discussed in more detail herein, waveform 220 represents displacement of device 210 in directions 292 and 293 detected at displacement module 211 as device 210 is moved in direction 291. Waveform 220 can be stored for example, as a series of values at memory locations of a memory within a computer system.

As another example, a displacement signature can be a string, series, or set of values such as bit string 230. As discussed in more detail herein, bit string 230 represents positive displacement (e.g., displacement in a selected direction such as a protrusion) with a value of 1 and negative displacement (e.g., displacement in a selected direction different from the direction selected for positive displacement such as a depression) with a value of 0. In other implementations, a displacement signature can be, for example, a set of values that vary between −10.0 and 10.0 that identify a direction of a displacement (e.g., positive displacement or negative displacement) and a degree or magnitude of the displacement (e.g., a relative or absolute measure of displacement or rate of displacement).

A displacement signature can be defined by device 210, which includes displacement module 211. Displacement module 211 detects or senses displacement (or motion or forces resulting from displacement). For example, displacement module 211 can include an accelerometer, a gyroscope, or other mechanism for detecting displacement. As a specific example, displacement module 211 can include a MEMS (microelectromechanical system) accelerometer. Device 210 can be any device including displacement module 211. For example, device 210 can be a computing system such as a notebook computer, a tablet device, a smartphone, or other computing system that includes a displacement module. As another example, device 210 can be a media player, a stylus, a laser pointer, or a pen that includes a displacement module. In some implementations, device 210 communicates with a computing system via a wired connection (e.g., a USB (Universal Serial Bus) connection) or a wireless connection (e.g., a Bluetooth® connection) to provide values from displacement module 211 to the computing system.

In the example illustrated in FIG. 2, as device 210 is moved along surface 201 (e.g., when a person drags or moves device 210 across tactile tag 200 along surface 201), displacement module 211 (an accelerometer in this example) detects or senses displacement and outputs or records values representing that displacement to generate waveform 220. In other words, as device 210 moves (or is moved) along surface 201 in direction 291, device 210 experiences displacement in directions 292 and 293 due to the protrusions and depressions of tactile tag 200. Tactile tag 200 is an example of a tactile tag. In other implementations, a tactile tag can be more complex. For example, in other implementation a tactile tag can include protrusions of multiple heights and/or depressions of multiple depths and/or additional protrusions and/or depressions than illustrated in FIG. 2.

This displacement is sensed as changes in acceleration at displacement module 211, and recorded as waveform 220. Waveform 220 can be defined by values output from a displacement module such as (or including) an accelerometer. In some implementations, values output from a displacement module are filtered, and waveform 220 is defined by the filtered values. For example, waveform 220 can be defined using a running average of values output from an accelerometer to smooth waveform 220. Referring to graph 280 of FIG. 2, when device 210 is not moving in direction 292 or direction 293, displacement module 211 senses approximately −1 g of acceleration (where “g” represents acceleration due to the mass of Earth). However, when device 210 ascends to the top of a protrusion or from a depression (i.e., moves in direction 292), displacement module 211 senses an increase in acceleration in direction 293 (or an increase in negative acceleration in graph 280) and then an increase in acceleration in direction 292 (or an increase in positive acceleration in graph 280) until the ascent is complete. Said differently, displacement in direction 292 is characterized by a brief spike in acceleration in direction 293 followed by a brief spike in acceleration in direction 292.

Similarly, when device 210 descends off a protrusion or to the bottom of a depression (i.e., moves in direction 293), displacement module 211 senses an increase in positive acceleration in graph 280 and then an increase in negative acceleration in graph 280 until the descent is complete. In other words, displacement in direction 293 is characterized by a brief spike in acceleration in direction 292 followed by a brief spike in acceleration in direction 293. That is, pairs of acceleration spikes in acceleration indicate displacement. In this example, a spike in negative acceleration followed by a spike in positive acceleration indicates displacement up (in direction 292), and a spike in positive acceleration followed by a spike in negative acceleration indicates displacement down (in direction 293).

Because the acceleration detected at displacement module 211 is related to the displacement of device 210, waveform 220 can be analyzed to identify a displacement signature of tactile tag 200 (or surface 201 of tactile tag 200). As illustrated in FIG. 2, a displacement signature can be extracted or determined from waveform 220 as bit string 230. For example, sections of waveform 220 following an increase in negative acceleration can be assigned a value of “1” indicating a protrusion, and sections of waveform 220 following an increase in positive acceleration can be assigned a value of “0” indicating a depression.

In some implementations, waveform 220 can be analyzed by sampling waveform 220 at periodic intervals, as illustrated in FIG. 2. In some implementations, waveform 220 can be stretched and/or compressed during the analysis to correct for variations in the rate at which device 210 is moved along surface 201 in direction 291. For example, stretching techniques applied to barcode scanning can be useful in correcting for variations in the rate (e.g., velocity) at which device 210 is moved along surface 201 in direction 291. As yet another example, in some implementations, displacement module 211 can detect or sense displacement in direction 291 in addition to directions 292 and 293. The displacement information for direction 291 can be used to determine at what points or times displacement for directions 292 and 293 should be sampled at waveform 220. In other words, displacement information for direction 291 can be used to determine at what portions waveform 220 should be sampled to define a displacement signature for surface 201 of tactile tag 200.

In some implementations, a barcode or other markings can be incorporated into a tactile tag. Such markings can be printed on, engraven into, or molded with a tactile tag. In some implementations, such markings can be used to determine or calibrate the rate at which device 210 is moved along surface 201. For example, device 210 can include an imaging module (not shown) such as a camera, barcode scanner, or other imaging module to identify such markings and determine a rate at which device 210 is moved along surface 201. As a specific example, such marking can be uniformly spaced or spaced at predetermined or defined distances one from another, and the imaging module can derive a velocity of movement based on elapsed time as device 210 is moved between markings.

Furthermore, in some implementation, such markings at a tactile tag can include or represent information or data. As a specific example, such a marking can be a quick response (QR) code that is read by an imaging module. Such marking can increase the information content stored at the tactile tag. In some implementations, such information or data represented by markings at a tactile tag can be encrypted. The displacement signature of the tactile tag (or determined from the tactile tag) can be an encryption key or can be used to access an encryption key to decrypt encrypted information stored at or represented by such markings.

As another example of generating a displacement signature, FIG. 3 illustrates a tactile tag, according to another implementation. Tactile tag 300 includes surface 301 and actuator 350. Actuator 350 is a device such as a solenoid, a speaker, a motor (e.g., a motor with a counterweighted shaft), a piezo-electric device, or other device that when actuated causes displacement at surface 301. Actuator 350 can therefore be actuated to cause displacement of device 210. In some implementations, the displacement is small (e.g., on the order of millimeters or microns), but nevertheless detectable at displacement module 211.

As discussed above, device 210 includes displacement module 211 that detects or senses displacement. Accordingly, device 210 can define a displacement signature for tactile tag 300 by sensing a pattern of displacement at surface 301 generated by actuator 350. As a specific example, actuator 350 can be a motor with a counterweighted shaft, and tactile tag 300 can include a processor (not shown) in communication with actuator 350. The processor causes actuator 350 to spin the counterweighted shaft according to a pattern, which induces displacement at surface 301 according to that pattern. That displacement is then sensed at displacement module 211 to define a displacement signature for tactile tag 300, which is correlated with the pattern. In other words, the pattern according to which the processor causes actuator 350 to actuate (or the displacement caused by that pattern of actuation) can be detected or sensed as the displacement signature for (or of) tactile tag 300 (or surface 301 of tactile tag 300).

Referring again to FIG. 1, after the displacement signature is defined at block 110, correlation of that displacement signature with a known displacement signature is determined at block 120. For example, a security management system can include a library or database of known displacement signatures (i.e., known displacement signatures of tactile tags), and can compare the displacement signature defined at block 110 with those known displacement signatures to determine whether that displacement signature is correlated with a known displacement signature. In some implementations, a security management system can receive an identifier of a known displacement signature in connection with a displacement signature, and determine whether that displacement signature is correlated with that known displacement signature.

A displacement signature can be said to be correlated with a known displacement signature if the displacement signature meets or exceeds a similarity threshold with the known displacement signature. In other words, the displacement signature can be said to be correlated with a known displacement signature if the displacement signature satisfies a similarity threshold with the known displacement signature. That is, the displacement signature can be said to be correlated with a known displacement signature if a predetermined percentage of the displacement signature is the same as a portion or portions of the known displacement signature. As a specific example, the displacement signature can be said to be correlated with a known displacement signature if the displacement signature (or relevant portion thereof) is 95% or more similar with the known displacement signature (or relevant portion thereof).

In some implementations, a security management system can provide the displacement signature generated at block 110 to a displacement signature service to determine whether the displacement signature is correlated with a known displacement signature. For example, the displacement signature service can be a resource that includes or accesses a library or database of known displacement signatures, and can compare the displacement signature received from the security management system implementing process 100 with those known displacement signatures to determine whether that displacement signature is correlated with a known displacement signature.

The displacement signature service can then provide information to the security management system implementing process 100 indicating whether the displacement signature is correlated with a known displacement signature. For example, the displacement signature service can provide an indication that the displacement signature is correlated with a known displacement signature or that the displacement signature is not correlated with a known displacement signature. In other implementations, the displacement signature service can provide additional information such as an identifier of the known displacement signature with which the displacement signature is correlated; a credential or authorization associated with the known displacement signature with which the displacement signature is correlated; a description of operations associated with the known displacement signature with which the displacement signature is correlated; a threshold distance associated with the known displacement signature, and/or other information. Alternatively, such information can be available at the security management system implementing process 100 (e.g., within a database) and associated with the known displacement signatures.

If the displacement signature is not correlated with a known displacement signature, an error can be reported at block 130. In some implementations, the reported error can prompt for definition of another displacement signature at block 110, and process 100 can be repeated. If the displacement signature is correlated with a known displacement signature, an operation is performed in response to the determination that the displacement signature is correlated with a known displacement signature at block 140. For example, the security management system implementing process 100 can perform one or more privileged operations if the displacement signature is correlated with a known displacement signature.

As another example, a trusted state of an entity can be established at block 140 in response to determining that the displacement signature is correlated with a known displacement signature. An entity is a client of a service or resource, a software application such as a user agent, a user account, or a context of a web application that can be in a trusted state (or any of a variety of trusted states) or an untrusted state. A trusted state is a state in which an entity is authorized to perform operations such as privileged operations that are not allowed when the entity is not in the trusted state. For example, such privileged operations can include accessing (e.g., reading, writing, or modifying) data such as confidential or restricted information, communicating via a communications link, communicating or associating with other entities, accessing an intranet or internal network of an enterprise, executing commands or applications, and/or other privileged operations. In some implementations, an entity accesses a credential such as a password or digital certificate to demonstrate to a resource or service that the entity is in a trusted state.

In response to determining that the displacement signature is correlated with a known displacement signature, the security management system implementing process 100 can establish a trusted state of an entity by modifying one or more state variables of the entity, by providing a credential to the entity (directly or via the device at which the displacement signature was defined), or by otherwise indicating that the entity is in a trusted state. For example, the tactile tag from which the displacement signature was generated at block 110 can be located in a physically secured location. Because the displacement signature generated at block 110 matches the known displacement signature of that tactile tag, the security management system can be determined to be physically located near that tactile tag and trusted or secured. Accordingly, the security management system can establish a trusted state of an entity such as an entity hosted at (or cohosted with) the security management system.

Process 100 illustrated in FIG. 1 is an example security management process. Other security management processes can include different and/or additional blocks or steps. For example, in some implementations, a security management process includes receiving a credential associated with a known displacement signature that is correlated with a displacement signature defined at block 110.

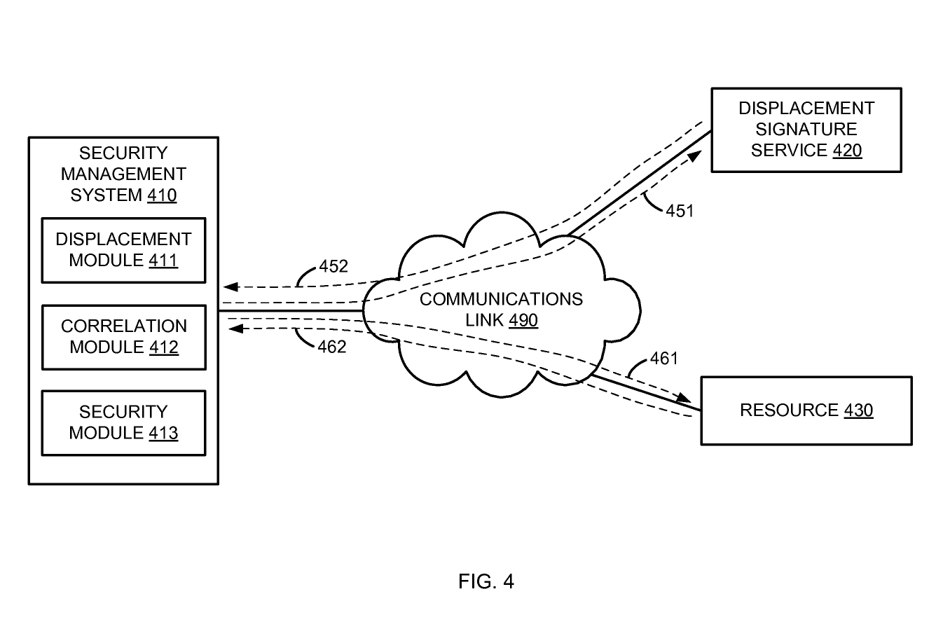

FIG. 4 is a schematic block diagram of an environment including a security management system, according to an implementation. Security management system 410 includes displacement module 411, correlation module 412, and security module 413. Although particular modules (i.e., combinations of hardware and software) such as engines are illustrated and discussed in relation to FIG. 4 and other example implementations, other combinations or sub-combinations of modules can be included within other implementations. Said differently, although modules illustrated in FIG. 4 and discussed in other example implementations perform specific functionalities in the examples discussed herein, these and other functionalities can be accomplished, implemented, or realized at different modules or at combinations of modules. For example, two or more modules illustrated and/or discussed as separate can be combined into a module that performs the functionalities discussed in relation to the two modules. As another example, functionalities performed at one module as discussed in relation to these examples can be performed at a different module or different modules. Moreover, in some implementations, some modules discussed in connection with one example implementation can be excluded in other implementations.

Displacement module 411 is a combination of hardware and software that determines (or detects or senses) displacement to define a displacement signature. For example, displacement module 411 can include an accelerometer or gyroscope and executable instructions stored at a memory and executed at a processor to interpret and/or analyze values output at the accelerometer or gyroscope.

In some implementations, displacement module 411 also determines a distance of movement. For example, using dead-reckoning methodologies, implementations of displacement module 411 including an accelerometer can determine an amount of movement of displacement module 411. As a specific example, in some implementations, displacement module 411 integrates acceleration values detected or sensed at displacement module 411 to determine whether security management system 410 has moved more or less than a threshold distance (e.g., a threshold distance from a location at which a displacement signature of a tactile tag was defined).

In some implementations, displacement module 411 can be physically separate from, but logically included within security management system 410. For example, displacement module 411 can be or can be implemented at a probe or other device in communication (e.g., via a communications link such as a wireless communications link) with a device such as a computing system hosting correlation module 412 and security module 413. That is, displacement module 411 can communicate displacement signatures to correlation module 412 and/or security module 413. In other implementations, displacement module 411, correlation module 412, and security module 413 can be hosted or implemented at a single device.

Correlation module 412 is a combination of hardware and software that determines whether a displacement signature is correlated with a known displacement signature. For example, correlation module 412 can provide a displacement signature to displacement signature service 420 to determine whether the displacement signature is correlated with a known displacement signature. As another example, correlation module 412 can access a library or database of known displacement signatures (not shown) at security management system 410, and compare a displacement signature with those known displacement signatures to determine whether the displacement signature is correlated with a known displacement signature.

Security module 413 is in communication with correlation module 412 to establish a trust state of an entity if a displacement signature is correlated with a known displacement signature. As specific examples, security module 413 can establish a trusted state of an entity by modifying one or more state variables of the entity, by providing a credential to the entity, or by otherwise indicating that the entity is in a trusted state. Additionally, in some implementations, security module 413 is in communication with displacement module 411 to revoke the trust status of the entity if displacement module 411 determines that it has moved more than a threshold distance. Additional detail regarding the functionalities of displacement module 411, correlation module 412, and security module 413 are discussed herein, for example, in relation to FIGS. 1, 2, 3, and 5. Said differently, displacement module 411, correlation module 412, and security module 413 can perform these functionalities as discussed in other examples described herein.

In the example illustrated in FIG. 4, security management system 410 uses a displacement signature to establish a trusted state of an entity to access resource 430. Displacement module 411 (or a device including displacement module 411 or a portion thereof) generates a displacement signature of a surface based on physical contact with the surface, for example, as discussed in relation to FIGS. 2 and 3. A representation of the displacement signature is provided to displacement signature service 420 by correlation module 412 as illustrated by communication 451 via communications link 490.

Communications link 490 includes devices, services, or combinations thereof that define communications paths between security management system 410, displacement signature service 420, resource 430, and/or other devices or services. For example, communications link 490 can include one or more of a cable (e.g., twisted-pair cable, coaxial cable, or fiber optic cable), a wireless link (e.g., radio-frequency link, indicative link, optical link, or sonic link), or any other connectors or systems that transmit or support transmission of signals. Moreover, communications link 490 can include communications networks such as a switch fabric, an intranet, the Internet, telecommunications networks, or a combination thereof. Additionally, communications link 490 can include proxies, routers, switches, gateways, bridges, load balancers, and similar communications devices. Furthermore, the connections or communications paths illustrated in FIG. 4 and discussed herein can be logical or physical.

Displacement signature service 420 compares the displacement signature with known displacement signatures to determine whether the displacement signature is correlated with a known displacement signature. For example, displacement signature service 420 can include or access a library or database of known displacement signatures that are associated with tactile tags. Additionally, displacement signature service 420 can access information such as credentials (e.g., permissions, passwords, or digital certificates) associated with the known displacement signatures that are provided to security management system 410 when displacement signatures that are correlated with those known displacement signatures are received from security management system 410.

In this example, displacement signature service 420 determines that the displacement signature provided by correlation module 412 is correlated with a known displacement signature, and provides a credential associated with that known displacement signature to correlation module 412 as illustrated by communication 452. Security module 413 receives the credential from correlation module 412 and establishes a trust state of an entity (not shown) hosted at security management system 410.

For example, security module 413 can provide the credential to an entity such as a user agent (e.g., a software application) configured to access restricted data at resource 430. The entity then sends a request for restricted data including the credential to resource 430 as illustrated by communication 461. Resource 430 validates the credential, and provides the restricted data as illustrated by communication 462. Thus, the restricted data is accessed by the entity as a result of the displacement signature defined by displacement module 411.

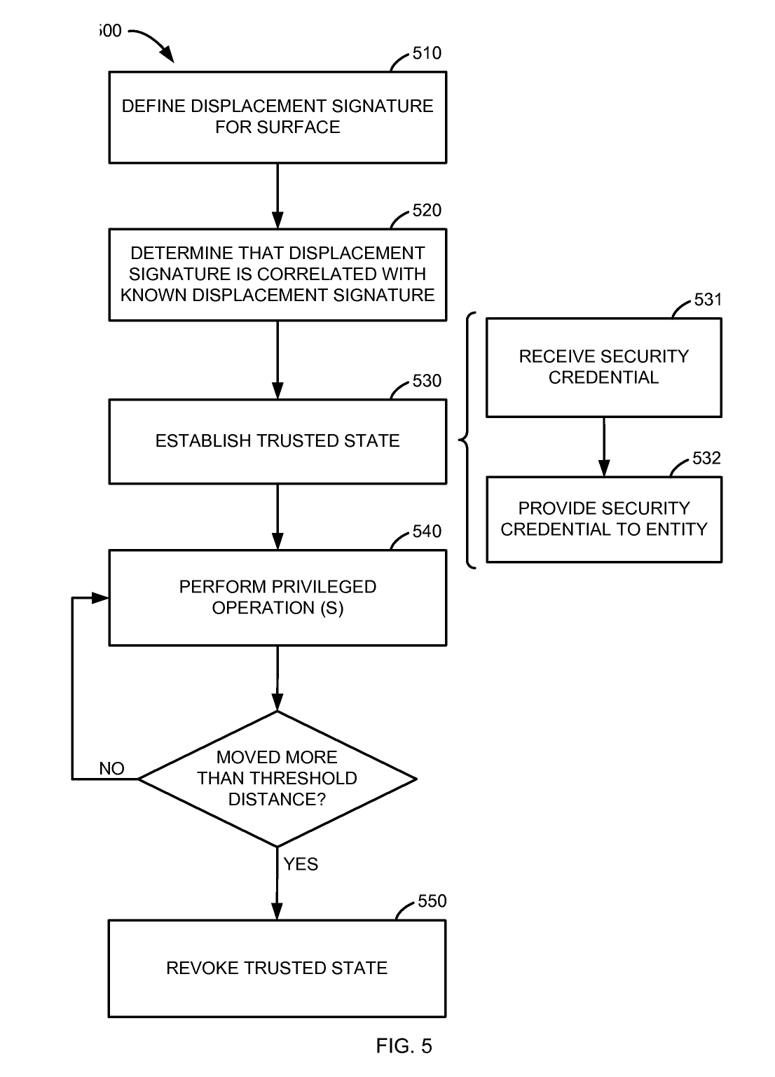

FIG. 5 is a flowchart of a security management process, according to another implementation. Although a particular implementation is discussed in relation to FIG. 5, the process illustrated in FIG. 5 and discussed herein can be applicable to other implementations. In this example, process 500 is implemented at a smartphone including an accelerometer. In other words, the smartphone is a security management system that includes an accelerometer as a displacement module. A user of the smartphone enters a room that includes a tactile tag. For example, a table in the room can include a tactile tag with a known displacement signature.

The smartphone (or an application hosted at the smartphone) defines a displacement signature for the surface of the tactile tag at block 510 by sampling an output of the accelerometer as the user moves the smartphone across the surface of the tactile tag. The smartphone then determines that the displacement signature is correlated with the known displacement signature of the tactile tag at block 520. In this example, the smartphone communicates with a displacement signature service to determine whether the displacement signature is correlated with the known displacement signature of the tactile tag. More specifically, the smartphone provides a representation of the displacement signature to the displacement signature service, and the displacement signature service provides an indication that the displacement signature is correlated with a known displacement signature to the smartphone. In other implementations, for example as discussed above, the smartphone can include a library or database of known displacement signatures, and the displacement signature defined at block 510 can be compared with those known displacement signatures to determine whether the displacement signature is correlated with a known displacement signature.

After determining that the displacement signature is correlated with the known displacement signature of the tactile tag, the smartphone establishes a trusted state of an entity hosted at (or in communication with) the smartphone at block 530. In the example illustrated in FIG. 5, the smartphone receives a credential (or security credential) from the displacement signature service at block 531 in response to a determination by the displacement signature service that the displacement signature is correlated with the known displacement signature of the tactile tag. The credential is then provided to the entity at block 532 to establish the trusted state of the entity.

In some implementations, the credential can be provided directly to the entity. For example, the entity can be hosted at a computing system separate from the smartphone, and the credential can be provided to the entity based on a relationship between the smartphone and the entity. As a specific example, the smartphone can indicate to the displacement signature service or some other service that the displacement signature is provided on behalf of the entity. As an example of such an indication, the smartphone can provide an identifier of the entity or a token associated with the entity to the displacement signature service with the displacement signature. The displacement signature service can then use the identifier or token to provide the credential to the intended entity. As another example, the smartphone can provide the displacement signature to the displacement signature service within a communications session (or session) associated with the entity.

The entity then performs privileged operations at block 540 based on the trusted state. For example, privileged operations can include accessing restricted data or communicating with a restricted service or resource. While the entity is performing the privileged operations, the smartphone (or a displacement module thereof) monitors movement to determine whether it moves more than a threshold distance. For example, the smartphone can integrate values output from the accelerometer and/or apply dead-reckoning methodologies to those values to determine whether the smartphone has moved more than a threshold distance from the location at which the displacement signature was defined. The threshold distance can be, for example, a distance associated with the known displacement signature and specific to the tactile tag. For example, the threshold distance can be less than a distance from the tactile tag to the door of the room. Thus, if the smartphone is removed from the room, the threshold distance will have been exceeded.

As another example, movement of the smartphone (or another device) from a tactile tag can be restricted to an arbitrary three-dimensional (3D) space (defined by a set of coordinates). For example, the 3D space can be a cone projected in a particular direction from (e.g., in front of) a tactile tag. In such implementations, directionality can be referenced from protrusions and/or depressions of the tactile tag. For example, using a gyroscope and an accelerometer, a displacement module can identify a direction of movement of the smartphone (or other device) across or along the tactile tag, and direction of movement of the smartphone after a displacement signature is generated. In other words, movement of the smartphone within the 3D space can be tracked with addition of a gyroscope to provide information on the orientation of the smartphone, with the direction of movement along the tactile tag defined as an initial or reference direction.

While the smartphone has not moved more than the threshold distance, the trusted state remains established. However, if the smartphone moves more than the threshold distance, the trusted state is revoked at block 550. For example, the smartphone can delete a credential to prevent an entity from further using the credential. As another example, the smartphone (e.g., a security module hosted at the smartphone) can revoke the trusted state by providing a revocation notification to the entity or can modify a state variable of the entity to cause the trusted state of the entity to be revoked. In some implementations, the smartphone can notify a resource or a security validation service with which a trust state or credential is validated by resources and/or services that the trust state should be revoked. In other words, after the smartphone moves more than the threshold distance from the tactile tag, the trusted state of the entity is revoked. As a specific example, the entity is unable to perform the privileged operations after the smartphone leaves the room.

In some implementations, the trusted state can also be revoked if the smartphone (or other device) ceases to be in communication with a service or computing system associated with the entity. For example, if the smartphone fails to provide a signal to such a service of computing system before a deadline (e.g., a periodic deadline), the trusted state can be revoked. Additionally, trusted state can also be revoked if the smartphone ceases to be associated with the entity. For example, if a communications session associated with the entity is severed or expired or if a user of the smartphone logs a user agent associated with the entity out of a service, the trusted state of the entity can be revoked.

Process 500 illustrated in FIG. 5 is an example security management process. Other security management processes can include different and/or additional blocks or steps and/or be implemented with different devices. For example, rather than a smartphone, process 500 can be implemented at a computing system including or coupled to a displacement module. In some implementations, the displacement module can be physically coupled to the computing system to restrict (either physically or logically) separation of the displacement module from the computing system. As a specific example, the trusted state can be revoked if the displacement module moves more than the threshold distance or is separated from the computing system.

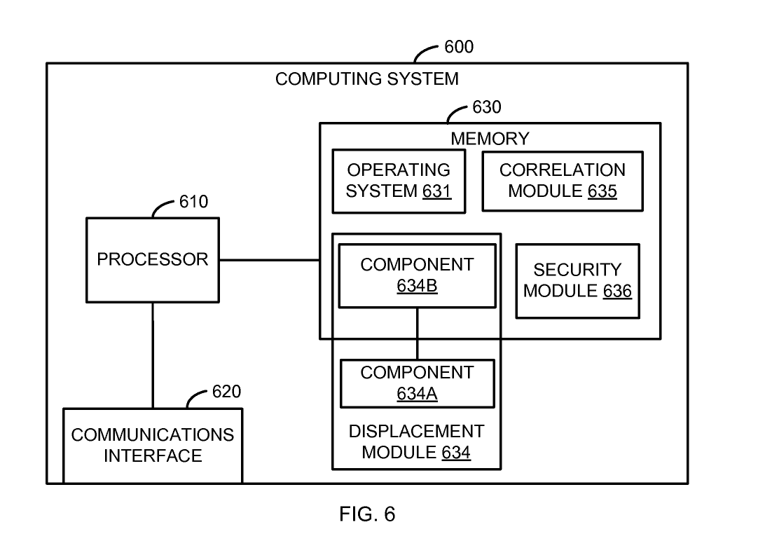

FIG. 6 is a schematic block diagram of a computing system hosting a security management system, according to an implementation. In the example illustrated in FIG. 6, computing system 600 includes processor 610, communications interface 620, and memory 630. Computing system 600 can be, for example, a personal computer such as a desktop computer or a notebook computer, a tablet device, a smartphone, or some other computing system. In some implementations, a computing system hosting a security management system is referred to itself as a security management system.

Processor 610 is any combination of hardware and software that executes or interprets instructions, codes, or signals. For example, processor 610 can be a microprocessor, an application-specific integrated circuit (ASIC), a graphics processing unit (GPU) such as a general purpose GPU (GPGPU), a distributed processor such as a cluster or network of processors or computing systems, a multi-core or multi-processor processor, or a virtual or logical processor of a virtual machine.

Communications interface 620 is a module via which processor 610 can communicate with other processors or computing systems via a communications link. As a specific example, communications interface 620 can include a network interface card and a communications protocol stack hosted at processor 610 (e.g., instructions or code stored at memory 630 and executed or interpreted at processor 610 to implement a network protocol) to receive and send data. As specific examples, communications interface 620 can be a wired interface, a wireless interface, an Ethernet interface, an IEEE 802.11 interface, or some other communications interface via which processor 610 can exchange signals or symbols representing data to communicate with other processors or computing systems.

Memory 630 is a processor-readable medium that stores instructions, codes, data, or other information. As used herein, a processor-readable medium is any medium that stores instructions, codes, data, or other information non-transitorily and is directly or indirectly accessible to a processor. Said differently, a processor-readable medium is a non-transitory medium at which a processor can access instructions, codes, data, or other information. For example, memory 630 can be a volatile random access memory (RAM), a persistent data store such as a hard-disk drive or a solid-state drive, a compact disc (CD), a digital versatile disc (DVD), a Secure Digital™ (SD) card, a MultiMediaCard (MMC) card, a CompactFlash™ (CF) card, or a combination thereof or of other memories. In other words, memory 630 can represent multiple processor-readable media. In some implementations, memory 630 can be integrated with processor 610, separate from processor 610, or external to computing system 600.

Memory 630 includes instructions or codes that when executed at processor 610 implement operating system 631 and a security management system including component 634B of displacement module 634, correlation module 635, and security module 636. In other words, a security management system including displacement module 634B, correlation module 635, and security module 636 is hosted at computing system 600.

As illustrated in FIG. 6, a displacement module can include multiple components or components. Specifically in the example illustrated in FIG. 6, displacement module 634 includes component 634B and component 634A. Component 634A can be, for example, a device such as an accelerometer, a gyroscope or other device that detects or senses displacement and/or movement. Component 634B can be, for example, instructions that when executed at processor 610 access, interpret, and/or analyze values output from component 634A.

In some implementations, component 634A of displacement module 634 can be external to computing system 600. For example, component 634A of displacement module 634 can be coupled to computing system 600 via a USB interface (not shown).

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. As another example, functionalities discussed above in relation to specific modules or elements can be included at different modules, engines, or elements in other implementations. Furthermore, it should be understood that the systems, apparatus, and methods described herein can include various combinations and/or sub-combinations of the components and/or features of the different implementations described. Thus, features described with reference to one or more implementations can be combined with other implementations described herein.

As used herein, the term “module” refers to a combination of hardware (e.g., a processor such as an integrated circuit or other circuitry) and software (e.g., machine- or processor-executable instructions, commands, or code such as firmware, programming, or object code). A combination of hardware and software includes hardware only (i.e., a hardware element with no software elements), software hosted at hardware (e.g., software that is stored at a memory and executed or interpreted at a processor or software that is stored or encoded at a non-transient processor-readable memory), or hardware and software hosted at hardware.

Additionally, as used herein, the singular forms “a,” “an,” and “the” include plural referents unless the context clearly dictates otherwise. Thus, for example, the term “module” is intended to mean one or more modules or a combination of modules. Moreover, the term “provide” as used herein includes push mechanisms (e.g., sending data to a computing system or agent via a communications path or channel), pull mechanisms (e.g., delivering data to a computing system or agent in response to a request from the computing system or agent), and store mechanisms (e.g., storing data at a data store or service at which a computing system or agent can access the data). Furthermore, as used herein, the term “based on” means “based at least in part on.” Thus, a feature that is described as based on some cause, can be based only on the cause, or based on that cause and on one or more other causes.

What is claimed is:

1. A processor-readable medium including code representing instructions that when executed at a processor cause the processor to:
access a displacement signature defined in relation to physical contact with a surface;
determine that the displacement signature is correlated with a known displacement signature; and
perform an operation in response to determining that the displacement signature is correlated with the known displacement signature.

2. The processor-readable medium of claim 1, wherein the operation includes establishing a trusted state of an entity, the processor-readable medium further including code representing instructions that when executed at the processor cause the processor to:
monitor movement of a device at which the displacement signature was defined.

3. The processor-readable medium of claim 1, wherein the displacement signature is defined using an accelerometer at a device and the operation includes establishing a trusted state of an entity, the processor-readable medium further including code representing instructions that when executed at the processor cause the processor to:
monitor movement of the device using the accelerometer.

4. The processor-readable medium of claim 1, wherein the operation includes establishing a trusted state of an entity, the processor-readable medium further including code representing instructions that when executed at the processor cause the processor to:
determine that a device at which the displacement signature was defined has moved more than a threshold distance; and
revoke the trusted state of the entity in response to determining that the device has moved more than the threshold distance.

5. The processor-readable medium of claim 1, wherein the operation is a privileged operation and determining that the displacement signature is correlated with the known displacement signature includes providing the displacement signature to a displacement signature service, the processor-readable medium further including code representing instructions that when executed at the processor cause the processor to:
receive a security credential to perform the privileged operation.

6. The processor-readable medium of claim 1, wherein the operation is a privileged operation and determining that the displacement signature is correlated with the known displacement signature includes providing the displacement signature to a displacement signature service, the processor-readable medium further including code representing instructions that when executed at the processor cause the processor to:
receive a security credential to perform the privileged operation;
determine that a device at which the displacement signature was defined has moved more than a threshold distance; and
revoke the security credential in response to determining that the device has moved more than the threshold distance.

7. The processor-readable medium of claim 1, wherein the known displacement signature is associated with a tactile tag including the surface.

8. The processor-readable medium of claim 1, further including code representing instructions that when executed at the processor cause the processor to:
detect at an accelerometer of a device displacement of the device in a first direction along the surface substantially perpendicular to movement of the device in a second direction along the surface, the displacement signature defined based on the displacement.

9. The processor-readable medium of claim 1, further including code representing instructions that when executed at the processor cause the processor to:
detect at an accelerometer of a device displacement of the device in a first direction along the surface substantially perpendicular to movement of the device in a second direction along the surface to generate a waveform, and
derive values from the waveform to define the displacement signature.

10. A security management system, comprising:
a displacement module to define a displacement signature for a surface and to monitor movement of a device;
a correlation module to determine whether the displacement signature is correlated with a known displacement signature; and
a security module in communication with the correlation module and the displacement module to establish a trusted state of an entity if the displacement signature is correlated with the known displacement signature and to revoke the trusted state of the entity if the displacement module determines the device has moved more than a threshold distance.

11. The system of claim 10, wherein:
the displacement module includes an accelerometer, detects at the accelerometer displacement of the device in a first direction along the surface substantially perpendicular to movement of the device in a second direction along the surface to generate a waveform, and derives discrete values from the waveform to define the displacement module.

12. The system of claim 10, wherein:
the correlation module communicates with a displacement signature service via a communications link to determine whether the displacement signature is correlated with the known displacement signature.

13. The system of claim 10, wherein:
the correlation module provides a security credential to the security module if the displacement signature is correlated with the known displacement signature; and
the security module revokes the security credential if the displacement module determines the device has moved more than a threshold distance.

14. A security management method, comprising:
detecting at an accelerometer of a device displacement of the device in a first direction along a surface substantially perpendicular to movement of the device in a second direction along the surface;
defining a displacement signature based on the detecting;
determining that the displacement signature is correlated with a known displacement signature; and
establishing a trusted state of an entity if the displacement signature is correlated with the known displacement signature.

15. The security management method of claim 14, further comprising:
monitoring at the accelerometer movement of the device after the detecting; and
revoking the trusted state of the entity if the device has moved more than a threshold distance.
